(19) United States
(12) Patent Application Publication
(10) Pub. No.: US 2007/0064603 A1
(43) Pub. Date: Mar. 22, 2007

(54) Method of provisioning network elements to perform a service

(76) Inventors: Sean Chen, Sunnyvale, CA (US); Shin-Chung Soon, Dublin, CA (US); Holly Chen, San Ramon, CA (US)

Correspondence Address: BROOKS KUSHMAN P.C., 1000 TOWN CENTER, TWENTY-SECOND FLOOR, SOUTHFIELD, MI, 48075, US

(21) Appl. No.: 11/229,874

(22) Filed: Sep. 19, 2005

(51) Int. Cl. H04L 12/26

(52) U.S. Cl. 370/230

(57) ABSTRACT

A method of provisioning a network element to perform a service. The method comprising determining a number of service elements associated with provisioning the network element to perform the service, associating a number of forwardly configurable files with the service elements, and generating provisioning instructions for use in configuring the network element to perform the services.

### BACKGROUND OF THE INVENTION

1. Field of the Invention

The present invention relates to methods of provisioning network elements to perform a service.

2. Background Art

Electronic networks typically include a number of network elements, such as routers, bridges, gateways, servers, hubs, and the like, to provide network related services. Provisioning commands are electronically transported to the network elements to provision the operation thereof. The provisioning commands may specify any number of configuration and operational characteristics associated with governing the performance of the network elements.

### BRIEF DESCRIPTION OF THE DRAWINGS

The present disclosure is pointed out with particularity in the appended claims. However, other features of the present disclosure will become more apparent and the present disclosure will be best understood by referring to the following detailed description and the accompany drawings in which:

FIG. 1 illustrates a system in accordance with one non-limiting aspect of the present disclosure;

FIG. 2 illustrates a flowchart of method of configuring one or more network elements to provide a service in accordance with one non-limiting aspect of the present disclosure;

FIG. 3 illustrates a directional graph of a number of provisioning commands associated with providing a VPN service in accordance with one non-limiting aspect of the present disclosure; and

FIG. 4 is a diagrammatic representation of a machine in the form of a computer system in accordance with one non-limiting aspect of the present disclosure.

### DETAILED DESCRIPTION OF THE PREFERRED EMBODIMENT(S)

One non-limiting aspect of the present disclosure relates to a method of provisioning a network element to perform a service. The method includes determining a number of service elements associated with provisioning the network element to perform the service, associating a number of forwardly configurable files with the service elements, configuring a provisioning tool to generate provisioning instructions for use in provisioning the network element to perform the service as a function of information extracted from the forwardly configurable files, and updating the provisioning instructions generated by the provisioning tool as a function of updates to one or more of the forwardly configurable files such that updates to the provisioning instructions are made without rebuilding the provisioning tool.

One non-limiting aspect of the present disclosure relates to a computer-readable medium for use in provisioning a network element to perform a service. The computer-readable includes instructions for determining a number of service elements associated with provisioning the network element to perform the service, associating a number of forwardly configurable files with the service elements, and generating provisioning instructions for use in provisioning the network element to perform the service as a function of information extracted from the forwardly configurable files.

One non-limiting aspect of the present disclosure relates to a system having a number of network elements provisionable to perform a service a provisioning tool in communication with the network elements. The provisioning tooling includes a message generation portion configured to generate provisioning messages for use in provisioning the network element to perform the service and a forwardly configurable portion having a number of service elements associated with the service. The forwardly configurable portion includes features for receiving inputs regarding provisioning commands required to provision the network element to perform the service. The message generation portion includes features for extracting information from the forwardly configurable portion when generating the provisioning messages.

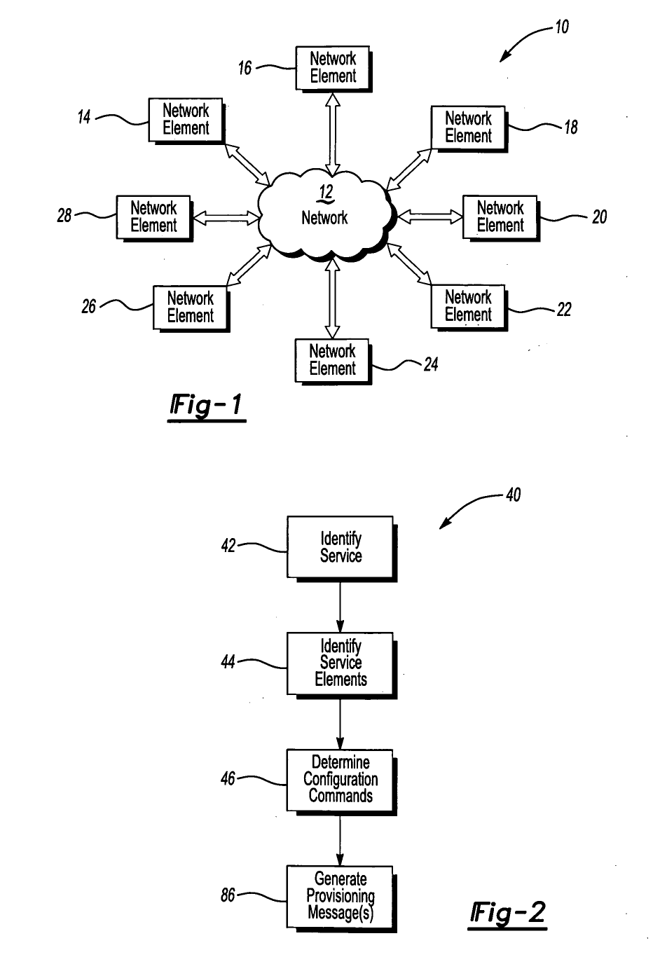

FIG. 1 illustrates a system 10 in accordance with one non-limiting aspect of the present disclosure. The system 10 generally relates to a network environment having a network 12 and a number of network elements 14-26. This environment may be associated with any environment wherein electronic signals are communicated from location to another over suitable wireline and/or wireless communication mediums.

The network 12 may be associated with any public or private, virtual or non-virtual, network having features suitable for transmitting electronic signals. The network 12 may be associated with a service provider (not shown), such as telecommunications, satellite, cable, data, or other service provider. The network 12 may be associated with any number of other networks and configured to support any number of geographical areas.

The network elements 14-26 relate to features, nodes, infrastructures, and other elements associated with supporting the operation of or permitting access to the network 12. The network elements 14-26 may include any type of network element associated with a telecommunication, television, data, satellite, and/or cable system. For example, the network elements may be routers, gateways, hubs, central offices (COs), service switching points (SSP), soft switches, signal transfer points (STPs), service control points (SCPs), service nodes (SNs), service package applications (SPAs), mobile switching centers (MSCs), home location registers (HLRs), visitor location registers (VLRs), server offices, server switches, feature servers, application program interfaces (APIs), bridges, servers, settop boxes (STBs), digital video recorders (DVRs), computers, and the like.

A network provisioning tool 28 may be included to facilitate provisioning of the network elements 14-26. The provisioning tool 28 may include a computer-readable medium or other feature sufficiently configured to execute logical operations. The provisioning tool 28 may be included in a software application or other item for use by a computer or other device having capabilities for generating electronic signals. The provisioning tool 28 may reside on a network node, computer server, one of the network elements, or some other location in electrical communication with the network. It may be associated with the service provider or an independent entity associated with a vendor or an information technology support provider. The provisioning tool 28 may be configured to emit provisioning signals according to any number of protocols and standards to facilitate provisioning any number and type of network element 14-26.

The provisioning tool 28 may be configured to providing a graphical user interface (GUI) or other portal (not shown). The GUI may be used to input instructions and other user commands to the provisioning tool 28. Likewise, the GUI may used to communicate instructions, menus, and other features to the user thereof, such as to facilitate selecting variables and parameters associated with generating the provisioning signals.

The provisioning tool 28 may be configured to provision the network elements 14-26 through provisioning messages. Multiple provisioning messages may be generated for each network element 14-26 and communicated thereto to provision the operation thereof. The provisioning messages may be generated anytime new network elements 14-26 are deployed and/or if other changes to deployed network elements are desired. The provisioning tool 28 may include features for automatically locating and provisioning new network elements and/or features for automatically updating provisioning of existing network elements.

FIG. 2 illustrates a flowchart 40 of a method of configuring one or more network elements 14-26 to provide a service. The service may be associated with any number of services provided by the network elements 14-26 and the provider associated with the support thereof. The service may relate to network related services, such as configuring VPNs, network security, virtual local area networks (VLANs), and the like where operations of multiple network elements 14-26 may be need to be provisioned and coordinated.

Block 42 relates to identifying the service to be configured and a number of network elements 14-26 associated with supporting the selected service. The service may be identified by a system operator, customer, or other individual associated with providing network services. Likewise, the service may be identified in an automated process, such as through the use of a network monitoring computer having capabilities to monitor the network elements 14-26 and to provision the operation thereof.

Block 44 relates to identifying a number of network elements 14-26 associated with provisioning the service. The service elements relate to individual logical entities required to provision the network elements 14-26 to provide the service. Each service element may include several provisioning commands that are sequentially inputted to provision the logical entity. The number of service elements is generally related to the provisioning protocols required of the particular network element 14-26 being configured. As such, the service elements and the number thereof may be depend on particular manufacturers and operating systems associated therewith.

The service elements, as described above, are generally defined as a function of the service and network elements 14-26 associated therewith. The provisioning commands associated with each service element may vary according to the provisioning characteristics desired by the system operator and/or customer. Accordingly, one problem with provisioning the network elements 14-26 relates to determining the appropriate provisioning commands.

Block 46 relates to determining the provisioning commands for each of the service elements. In accordance with one aspect of the present disclosure, the provisioning commands may be determined by the system operator according to desired operation characteristics and known capabilities for the network elements 14-26. In accordance with another aspect of the present disclosure, the provisioning commands may be determined from deployed network elements 14-26 already supporting the desired service.

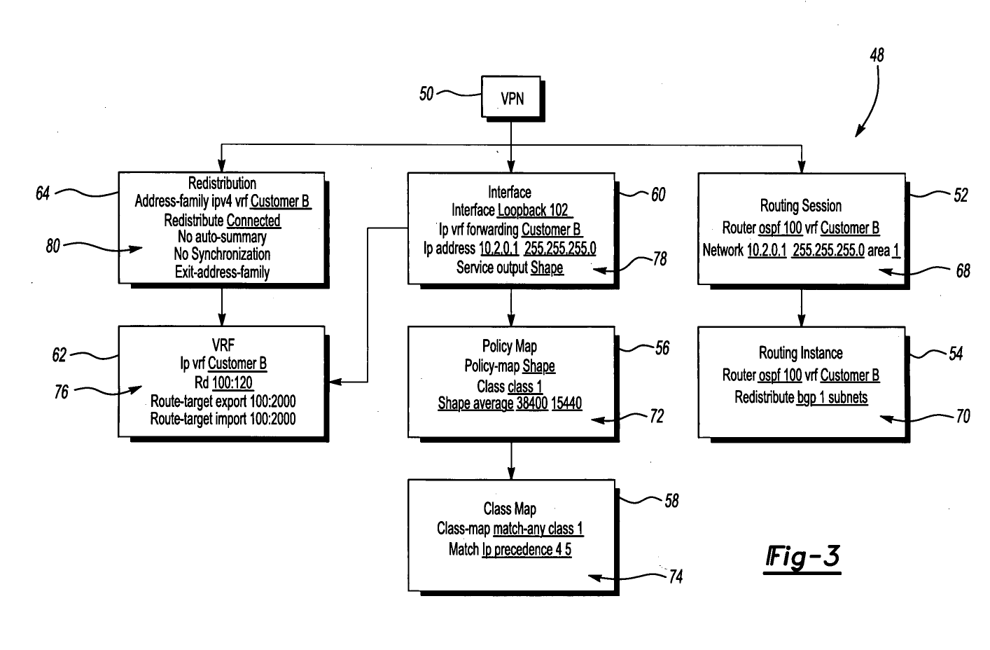

In more detail, the provisioning commands may be determined by the provisioning synchronizing with deployed network elements 14-26 and creating a database of the provisioning commands used to provision the operation thereof. FIG. 3 illustrates a directional graph 48 of a number of provisioning commands associated with providing a VPN service 50. The directional graph includes a number of services elements 52-64 commonly associated with provisioning a VPN, namely routing session, routing instance, interface, policy map, class map, VRF (define), and redistribution.

Each of the service elements 52-64 includes one or more provisioning commands 68-80, commonly referred to as command lines or command line interfaces (CLIs). The provisioning commands 68-80 may be divided into three parts, beginning from left to right and comprising labels, choices, and values. The labels are descriptors used to identify the nature of the provisioning command. The choices are Boolean variables that may be selected as a function of the corresponding label. The values are inputted variables related to the label and selected choice. Of course, the present disclosure is not limited to provisioning commands of this format and fully contemplates the use of provisioning commands having more or less of these features. The directional graph 48 may be used to capture complex dependency and parameterization options of the commands used for a specific service provisioning purpose. The three attributes, label, choice, and value are associated with each of the commands in the directional graph 48 to further characterize the exact usage of the command for a service provisioning scenario.

The provisioning tool 28 may be configured to include a number of directional graphs 48 for a number of services and a number of network elements 14-26. The directional graphs 48 included with the provisioning tool 28 may be templates having only the service elements and provisioning command labels, i.e., the choice and/or value portions are blanks inputted by the system operator or through synchronization. Once populated, the directional graph 48 may be stored as a function of the service and network elements 14-26 associated therewith, such as for use in reprovisioning the operation thereof.

Block 86 relates to generating provisioning messages for use in provisioning operation of one or more of the network elements 14-26 to provide the desired service. The provisioning messages may be communicated according to any number of protocols and messaging formats associated with the network elements 14-26 and may vary from network element to network element. In general, the provisioning messages include instructions associated with programming or otherwise provisioning the network elements 14-26 according to the provisioning commands specified in the service elements and detailed in the corresponding directional graph 48.

The provisioning messages are generated by the provisioning tool 28 according to the direction graphs associated therewith. In general, one or more provisioning messages are generated for each service element 52-64 to provision the network elements 14-26 with the provisioning commands associated therewith. In some cases, the provisioning messages are sequentially generated according to particular requirements of the provisioning processes.

As shown with the bolded portions of the communication commands, one or more of the commands 68-80 may be related to one or more other service elements 52-64. This dependency requires parsing of the directional graph 48 and communication of the provisioning commands 68-80 in a particular order, and therefore, may require provisioning of extended service elements prior to provisioning of root service elements 52-64. For example, this requires provisioning of the class map service element before provisioning of the policy map as the policy map includes a dependency to the ‘class 1’ value of the class map service element.

The provisioning tool 28 is configured with a message generation portion and a forwardly configurable portion. The message generation portion is a hard-coded program that looks towards to the forwardly configurable portion when executing operations. The message generation portion includes transformation logic associated with accepting the input parameter values from a human through the GUI or through a piece of software and converting the provisioning commands to instructions suitable for programming the network elements 14-26. It also includes features for sequentially communicating the provisioning messages according to the order defined in the directional graphs 48.

As one skilled in the art will appreciate, the message generation portion may be a software program or other self-executing arrangement compiled from source code or similar programming logic. The building of the message generation portion is relatively complex and requires numerous lines of codes. The present disclosure desires to configure the message generation portion to include pointers or other features for extracting information from the forwardly configurable portion. By looking to the forwardly configurable portion when generating messages, the message generation portion is able to receive updated information without requiring rebuilding.

For example, the forwardly configurable portion may be associated with the directional graphs 48 and the values inputted for the provisioning commands. The message generation portion is configured to extract information from the selected directional graph for use in generating the provisioning messages such that any changes to the directional graphs 48 are automatically incorporated through the information extraction. This eliminates the need to change the source code or otherwise rebuild the messaging portion to issue provisioning messages for the changes. This is advantageous when updating provisioning of the network elements 14-26 as it only requires updating the forwardly configurable portion of the provisioning tool, and not the messaging generation portion.

Optionally, the forwardly configurable portion of the provisioning tool 28 may be associated with data files, such as easily changeable extensive markup language (xml schema) files. Xml files may be associated with an entire directional graph 48 and/or individually for each of the service elements 52-64 specified in the directional graph 48. In this manner, a single xml file related to the particular provisioning changes needs to be updated and rebuilt. This limits provisioning processing delays and the likelihood of introducing errors.

Multiple provisioning messages may be required to provision multiple network elements 14-26. For example, one service may relate to providing a virtual private network (VPN). The creation and maintenance of the VPN may require provisioning of one or more network elements and the reprovisioning thereof as new hardware, software, and/or firmware is introduced.

The provisioning tool 28 may be configured to logically partition provisioning commands used to provision operation of the network elements 14-26. The partitioning includes representing the logical structure of the provisioning commands as schemas or other data files. The schemas may include a number of service elements 52-64 that together comprise the provisioning commands.

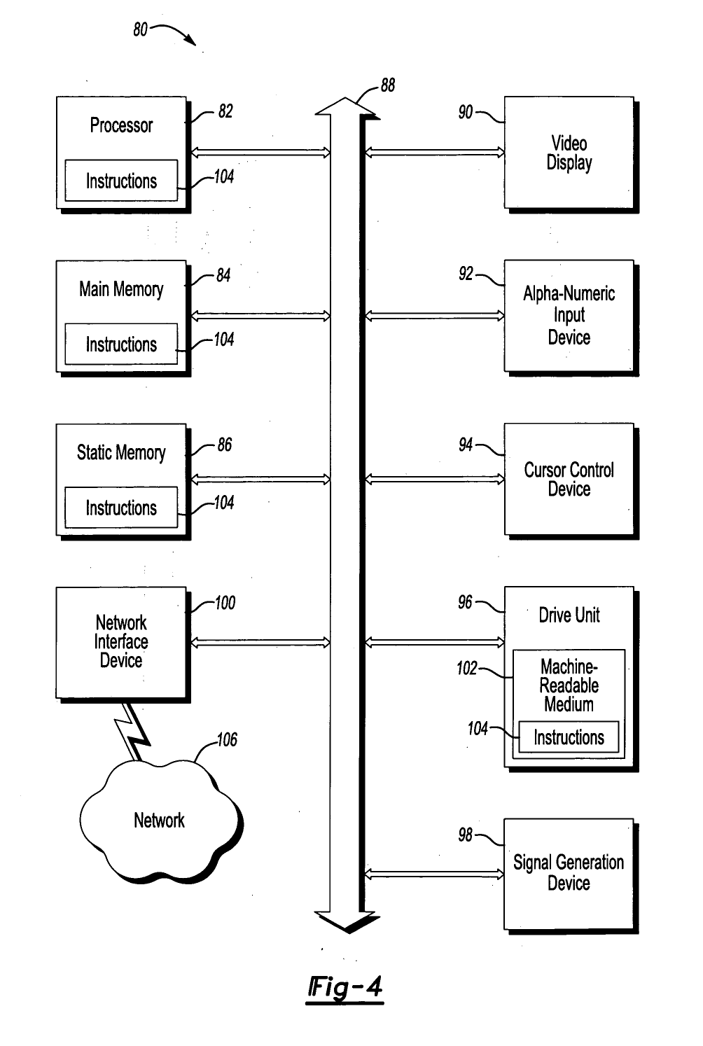

FIG. 4 is a diagrammatic representation of a machine in the form of a computer system 80 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present disclosure includes broadly any electronic device that provides voice, video or data communication.

Further, while a single machine is illustrated, the term “machine” shall also be taken to include any collection of machines that individually or jointly execute a set (or multiple sets) of instructions to perform any one or more of the methodologies discussed herein.

The computer system 80 may include a processor 82 (e.g., a central processing unit (CPU), a graphics processing unit (GPU), or both), a main memory 84 and a static memory 86, which communicate with each other via a bus 88. The computer system 80 may further include a video display unit 90 (e.g., a liquid crystal display (LCD), a flat panel, a solid state display, or a cathode ray tube (CRT)). The computer system 80 may include an input device 92 (e.g., a keyboard), a cursor control device 94 (e.g., a mouse), a disk drive unit 96, a signal generation device 98 (e.g., a speaker or remote control) and a network interface device 100.

The disk drive unit 96 may include a machine-readable medium 102 on which is stored one or more sets of instructions (e.g., software 104) embodying any one or more of the methodologies or functions described herein, including those methods illustrated in herein above. The instructions 104 may also reside, completely or at least partially, within the main memory 84, the static memory 86, and/or within the processor 82 during execution thereof by the computer system 80. The main memory 84 and the processor 82 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 104, or that which receives and executes instructions 104 from a propagated signal so that a device connected to a network environment 106 can send or receive voice, video or data, and to communicate over the network 106 using the instructions 104. The instructions 104 may further be transmitted or received over the network 106 via the network interface device 100.

While the machine-readable medium 102 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “disclosure” merely for convenience and without intending to voluntarily limit the scope of this application to any single disclosure or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

While embodiments of the disclosure have been illustrated and described, it is not intended that these embodiments illustrate and describe all possible forms of the disclosure. Rather, the words used in the specification are words of description rather than limitation, and it is understood that various changes may be made without departing from the spirit and scope of the disclosure.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of provisioning a network element to perform a service, the method comprising:
determining a number of service elements associated with provisioning the network element to perform the service;
associating a number of forwardly configurable files with the service elements;
configuring a provisioning tool to generate provisioning instructions for use in provisioning the network element to perform the service, the provisioning tool configured to generate the provisioning instructions as a function of information extracted from the forwardly configurable files; and
updating the provisioning instructions generated by the provisioning tool as a function of updates to one or more of the forwardly configurable files such that updates to the provisioning instructions are made without rebuilding the provisioning tool.

2. The method of claim 1 further comprising determining a number of provisioning commands associated with provisioning the network element to perform the service and determining the service elements as a function of the provisioning commands.

3. The method of claim 2 further comprising configuring the provisioning tool to include a hard-code portion and a forwardly configurable portion.

4. The method of claim 2 further comprising determining the service elements such that each service element includes at least one dependency to another service element.

5. The method of claim 4 further comprising configuring one or more of the forwardly configurable files to be an extensive markup language (xml) schema.

6. The method of claim 4 further comprising providing a number of directional graphs for a number of services, the directional graphs specifying the service elements associated with each service, and determining the service elements as a function of a selected directional graph.

7. The method of claim 6 further comprising configuring the provisioning tool to extract information from the forwardly configurable files as a function of the selected directional graph.

8. The method of claim 1 further comprising updating a portion of the provisioning instructions according to information received by the provisioning tool from the network element during a synchronization process.

9. A computer-readable medium for use in provisioning a network element to perform a service, the computer-readable medium comprising instructions for:
determining a number of service elements associated with provisioning the network element to perform the service;
associating a number of forwardly configurable files with the service elements; and
generating provisioning instructions for use in provisioning the network element to perform the service as a function of information extracted from the forwardly configurable files.

10. The computer-readable medium of claim 9 further comprising instructions for updating the provisioning instructions as function of updates to one or more of the forwardly configurable files such that updates to the provisioning instructions are made without rebuilding.

11. The computer-readable medium of claim 9 further comprising instructions for determining a number of provisioning commands associated with provisioning the network element to perform the service and determining the service elements as a function of the provisioning commands.

12. The computer-readable medium of claim 11 further comprising instructions for determining the service elements such that each service element includes at least one dependency to another service element.

13. The computer-readable medium of claim 12 further comprising instructions for receiving signals from one or more extensive markup language (xml) schema forwardly configurable files.

14. The computer-readable medium of claim 12 further comprising instructions for providing a number of directional graphs for a number of services, the directional graphs specifying the service elements associated with each service, and determining the service elements as a function of the selected directional graph.

15. The computer-readable medium of claim 14 further comprising instructions for extracting information from the forwardly configurable files as a function of the selected directional graph.

16. The computer-readable medium of claim 9 further comprising instructions for updating a portion of the provisioning instructions according to information received by the provisioning tool from the network element during a synchronization process.

17. A system, the system comprising:
a number of network elements provisionable to perform a service; and
a provisioning tool in communication with the network elements, the provisioning tooling including a message generation portion configured to generate provisioning messages for use in provisioning the network element to perform the service, the provisioning tool further including a forwardly configurable portion having a number of service elements associated with the service and including features for receiving inputs regarding provisioning commands required to provision the network element to perform the service, wherein the message generation portion includes features for extracting information from the forwardly configurable portion when generating the provisioning messages.

18. The system of claim 17 further comprising one or more directional graphs for each service, the directional graphs specifying the service elements associated therewith.

19. The system of claim 18 wherein the message generation portion is configured to generate the provisioning messages according to a sequence specified by the associated directional graph.

20. The system of claim 18 wherein the message generation portion is configured to populate the provisioning commands associated with the service elements in a synchronization operation.

21. The system of claim 18 wherein the provisioning tool is configured to generate one or more of the directional graphs as a function of information collected from the network elements.

22. The system of claim 17 further comprising a graphical user interface for use in receiving the inputs.
